(19) United States
(12) Patent Application Publication
(10) Pub. No.: US 2015/0160357 A1
(43) Pub. Date: Jun. 11, 2015

(54) OBSTRUCTION OVERLAY CABLE

(71) Applicant: ION GEOPHYSICAL CORPORATION, Houston, TX (US)

(72) Inventors: Timothy B. Rigsby, Richmond, TX (US); Felix E. Bircher, Metairie, LA (US)

(21) Appl. No.: 14/564,551

(22) Filed: Dec. 9, 2014

Related U.S. Application Data
(60) Provisional application No. 61/914,162, filed on Dec. 10, 2013.

(51) Int. Cl. G01V 1/18

(52) U.S. Cl. CPC G01V 1/18; G01V 1/38

(57) ABSTRACT

The present invention generally relates to seismic data acquisition and more specifically to ocean bottom seismic data acquisition systems. An ocean bottom seismic cable may include a first section comprising a plurality of seismic sensors, wherein the first section is positioned on a floor of a body of water in an area where there are no or substantially no obstructions. The seismic cable may also include a second section coupled to the first section, wherein the second section is positioned above or overlays an obstruction, and wherein the second section does not include seismic sensors.

### CROSS-REFERENCE TO RELATED APPLICATIONS

This application claims priority to U.S. Provisional Application No. 61/914,162, OBSTRUCTION OVERLAY CABLE, filed Dec. 10, 2013, which is hereby incorporated by reference herein, in the entirety and for all purposes.

### BACKGROUND

1. Field of the Invention

The present invention generally relates to seismic data acquisition, and more specifically to ocean bottom seismic data acquisition systems.

2. Description of the Related Prior Art

In conventional marine seismic surveying, a vessel tows a seismic source, such as an airgun array, that periodically emits acoustic energy into the water to penetrate the seabed. Sensors, such as hydrophones, geophones, and accelerometers may be housed in sensor units at sensor nodes periodically spaced along the length of an ocean bottom cable (OBC) resting on the seabed. The sensors of the sensor node are configured to detect acoustic energy reflected off boundaries between layers in geologic formations. Hydrophones detect acoustic pressure variations, and geophones and accelerometers, which are both motion sensors, sense particle motion caused by the reflected seismic energy. Signals from these kinds of sensors are used to map the geologic formations.

### SUMMARY

The present invention generally relates to seismic data acquisition, and more specifically to ocean bottom seismic data acquisition systems. An ocean bottom seismic cable may include a first section comprising a plurality of seismic sensors, wherein the first section is positioned on a floor of a body of water in an area where there are no obstructions. The ocean bottom seismic cable may also include a second section coupled to the first section wherein the second section is positioned above an obstruction, and wherein the second section does not include seismic sensors.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is an example of a seismic survey according to an embodiment of the invention.

FIG. 2 is an example of an ocean bottom seismic cable according to an embodiment of the invention.

FIGS. 3A, 3B, 3C and 3D illustrate exemplary methods for deploying an ocean bottom seismic cable according to an embodiment of the invention.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Furthermore, while reference is made to a sea floor, ocean bottom and seabed herein, embodiments of the invention are not limited to use in a sea environment. Rather, embodiments of the invention may be used in any marine environment including oceans, lakes, rivers, etc. Accordingly, the use of the term sea, seabed, ocean bottom, sea floor, and the like, hereinafter should be broadly understood to include all bodies of water.

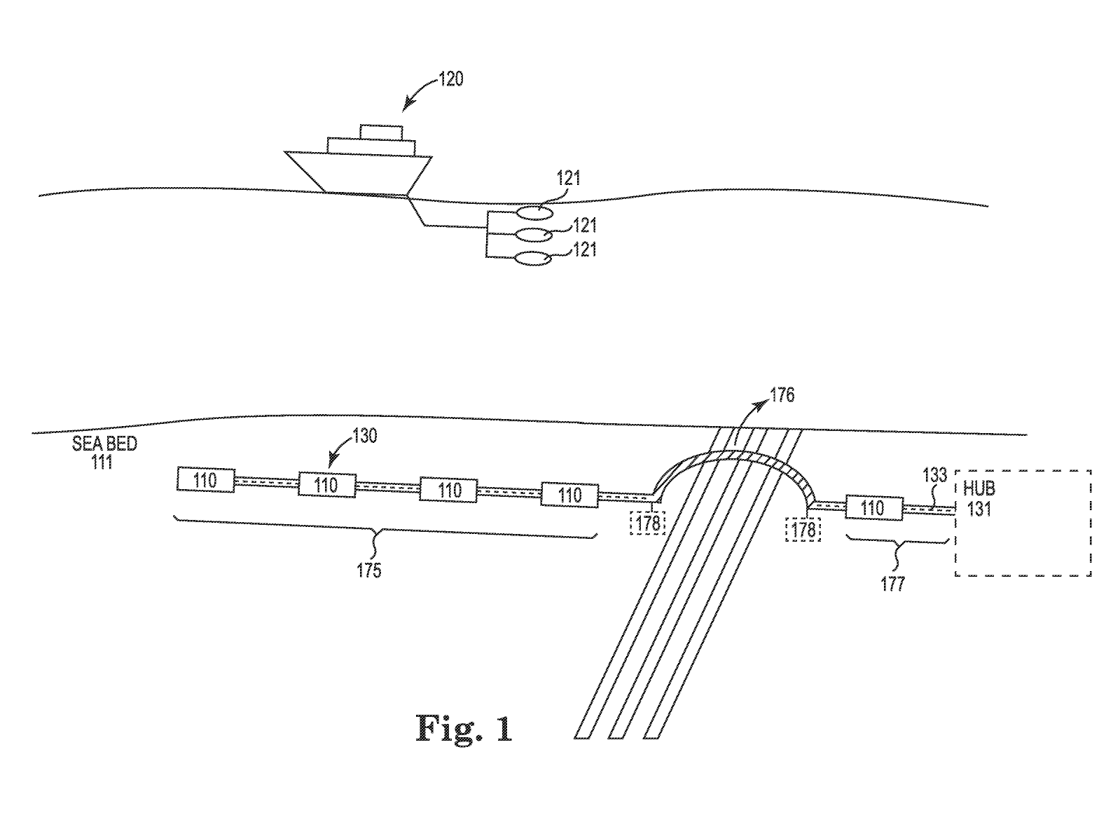

FIG. 1 illustrates an exemplary seismic survey according to an embodiment of the invention. As illustrated in FIG. 1, a source boat 120 may be configured to tow at least one seismic source 121 while conducting a seismic survey. In one embodiment, the seismic source 121 may be an air gun configured to release a blast of compressed air into the water column towards the seabed (or sea bed) 111. As shown in FIG. 1, the blast of compressed air generates seismic waves 122 which may travel down towards the seabed 111, and penetrate and/or reflect from sub-seabed surfaces. The reflections from the sub-surfaces may be recorded by sensor nodes 110 as seismic data, which may be thereafter processed to develop an image of the sub-surface layers. These images may be analyzed by geologists to identify areas likely to include hydrocarbons or other substances of interest.

As illustrated in FIG. 1, one or more ocean bottom cable assemblies (OBCs) 130 may be deployed on the seabed 111. OBCs generally comprise one or more sensor nodes that are physically coupled to one another by means of a cable (also referred to sometimes as wire or rope) or cable segments. In one embodiment, the sensor nodes may be electrically coupled to each other to transfer power, data, instructions, and the like. However, on other embodiments, the sensor nodes may be autonomous nodes comprising respective memory, power source, etc. In general, embodiments of the invention are applicable to any arrangement of sensors or sensor nodes, wherein the sensors or sensor nodes are coupled to each other by means of a cable, whether or not the cable is active, i.e., capable of transferring power, signals, and the like.

In one embodiment of the invention, the OBC 130 may be coupled to a respective sub-sea hub device 131 (referred to hereinafter simply as “hub”), as illustrated in FIG. 1. In one embodiment, the hub 131 may be placed on the seabed 111, as shown. However, in alternative embodiments, the hub 131 may be configured to float anywhere in the water column, for example as a buoyant hub or surface buoy. The hubs 131 may include data storage systems configured to store seismic data collected by the sensor nodes 110, a power system, etc.

While the OBC 130 is shown in FIG. 1 as comprising a plurality of nodes 110 coupled together via cable segments, in alternative embodiments, a different arrangement may be utilized. For example, in one embodiment, each sensor node 110 may be physically coupled, directly or indirectly, to a single cable segment to form the OBC 130.

In one embodiment, a link system 133 (hereinafter referred to simply as “link”) may transfer power, data, instructions, and the like from the hub 131 to the sensor nodes 110. In one embodiment, the link 133 may include a plurality of transmission lines. For example, a first plurality of transmission lines may be configured to transfer data between the sensor nodes and the hub, a second plurality of data lines may be configured to transfer instructions between the sensor nodes and the hub, and a third one or more transmission lines may transfer power from the hub to the sensor nodes. In alternative embodiments, the same set of transmission line or lines may be used to transfer one or more of seismic data, instructions, and/or power. Moreover, while a single link 133 is referred to herein, in alternative embodiments, a plurality of links may be included to transfer the seismic data, instructions, and power between the sensor nodes 110 and respective hubs 131.

In one embodiment of the invention, the sensor nodes 110 may be coupled to each other serially. Therefore, each node may be configured to receive and transfer instructions, data, power, etc. from a first node to a second node. In an alternative embodiment, the sensor nodes 110 may be connected in parallel via the link 133. In other words, one or more of the plurality of sensor nodes 110 may be directly coupled to a surface buoy or other hub 131 via the link 133. In other embodiments, the sensor nodes may be connected in any combination of serial and parallel connections with respect to each other, and direct and indirect coupling with the surface buoy.

While the link 133 is shown herein as a physical link, in alternative embodiments, the link 133 may be a wireless link. For example, communications between the sensor nodes and the hub devices may be performed using acoustic signals, electromagnetic signals, and the like. Furthermore, while each cable 130 is shown to be coupled with its own respective hub 131 in FIG. 1, in alternative embodiments, multiple cables 130 may be coupled to a single hub 131.

As described previously, in some embodiments, the ocean bottom cable 130 may comprise a plurality of autonomous sensor nodes that are coupled to one or more segments of a passive rope, or cable. Because autonomous nodes may include their own respective memory and power source, the hub 131 and link system 133 may be omitted. In general, embodiments of the invention are applicable to any type of cable based deployment of one or more seismic sensors on the ocean bottom, irrespective of whether the sensors are included in an autonomous node or a part of an ocean bottom cable including telemetry, power infrastructure, and the like.

Target areas for ocean bottom seismic data acquisition may include one or more obstructions on the ocean floor. Exemplary obstructions may include telephone lines, oil and gas pipelines, environmentally protected areas, shipwrecks, and the like. The obstructions may generally be of any type that is likely to either damage the seismic sensor cable or be damaged in some manner by the seismic sensor cable. For example, operation of the sensors, telemetry system, and/or power system of the seismic sensor cable may interfere with signals travelling on a telephone line, or signals to control valves in one or more oil and gas pipelines. Some obstructions such as environmentally sensitive areas may be at risk of being damaged by the seismic sensor cable, and therefore, legal (or other) requirements may necessitate that a seismic sensor cable avoid contact with such areas.

Embodiments of the invention provide methods and apparatus for seismic data acquisition using ocean bottom cables in areas where there may be one or more obstructions. FIG. 1 illustrates an exemplary obstruction 170 (may be a telephone line or oil and gas pipeline) on the seabed 111. As illustrated, the seismic sensor cable 130 may include at least a first section 175 and a second section 176. The section 175 may be directly on the seabed 111 in an area where there are no obstructions or no substantial obstructions. The second section 176 may be positioned over an area comprising the obstruction 170. A further section 177, coupled to the section 176 of the seismic sensor cable 130 may continue on past the obstruction 170, as shown in FIG. 1. The section 175 and/or 177 may include a plurality of seismic sensors.

In one embodiment of the invention, the section 176 of the seismic sensor cable 130 may be configured to float at least a predefined distance above the obstruction 170, as shown in FIG. 1. Accordingly, the section 176 may be made of or contain a neutrally buoyant and/or buoyant material, or otherwise be configured to be buoyant. For example, in one embodiment, the section 176 may be a gel or foam filled cable. In an alternative embodiment, the section 176 may include one or more floatation devices therein, or attached thereto, thereby causing the section 176 to float above the obstruction 170. Exemplary materials that may be used to form the section 176 include synthetic rope or any other material that may have or provide the section 176 with an overall density that is lower than that of water (e.g., sea water).

In one embodiment of the invention, the section 176 may include a portion of the link system 133, a power system, or the like, that couples the sensor nodes to a hub, for example as provided in an active section 176. By causing the section 176 to float at a predefined distance above the obstruction 170, embodiments of the invention avoid interference between signals transferred on the sensor cable 130 (e.g., through section 176) and signals transferred in the obstruction 170.

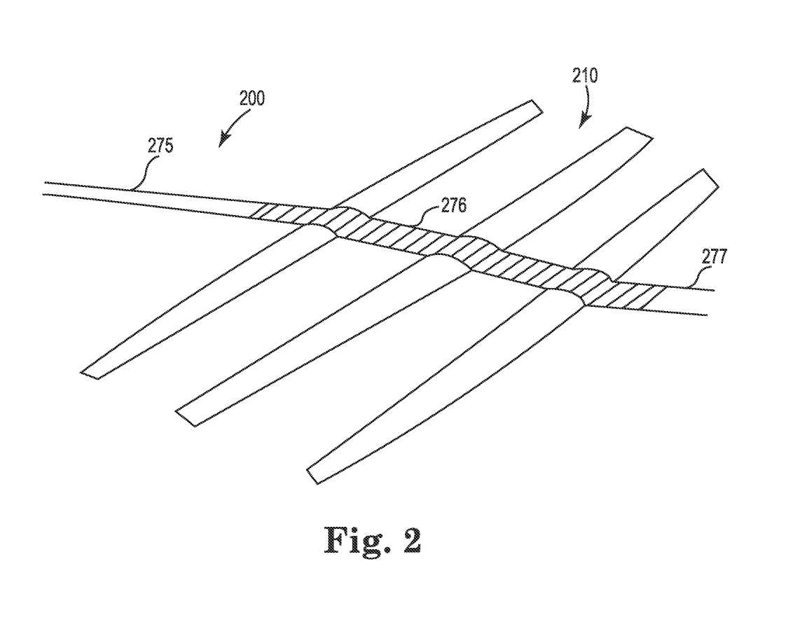

FIG. 2 illustrates another seismic sensor cable 200, according to an embodiment of the invention. The cable 200 may include at least a first section 275 and a second section 276. The section 275 may include one or more associated seismic sensors or seismic sensor nodes and may be located in an area where there are no obstructions or substantially no obstructions on a seabed. The section 276 may overlay an obstruction 210. In one embodiment, a third or further section 277 comprising seismic sensors may also couple to the section 276 and continue along the seabed in an area where there are no or substantially no obstructions. In one embodiment of the invention, the sections 275 and 277 may be configured to couple with one or more autonomous ocean bottom nodes. In an alternative embodiment, the sections 275 and 276 may be associated with interconnected seismic sensors, and each of sections 275 and 276 may be configured to couple with a respective hub device, e.g., the hub 131 of FIG. 1.

In one embodiment of the invention, the section 276 may be a passive section containing no electronics, or wiring for power or data transfer. Accordingly, the section 276 may overlay the obstruction and be in contact therewith, without interfering with any communications or signals that may be carried by the obstruction 210. Exemplary materials that may be used to form the section 276 include synthetic rope or any other material that may have or provide the section 276 with an overall density that is higher or lower than that of sea water.

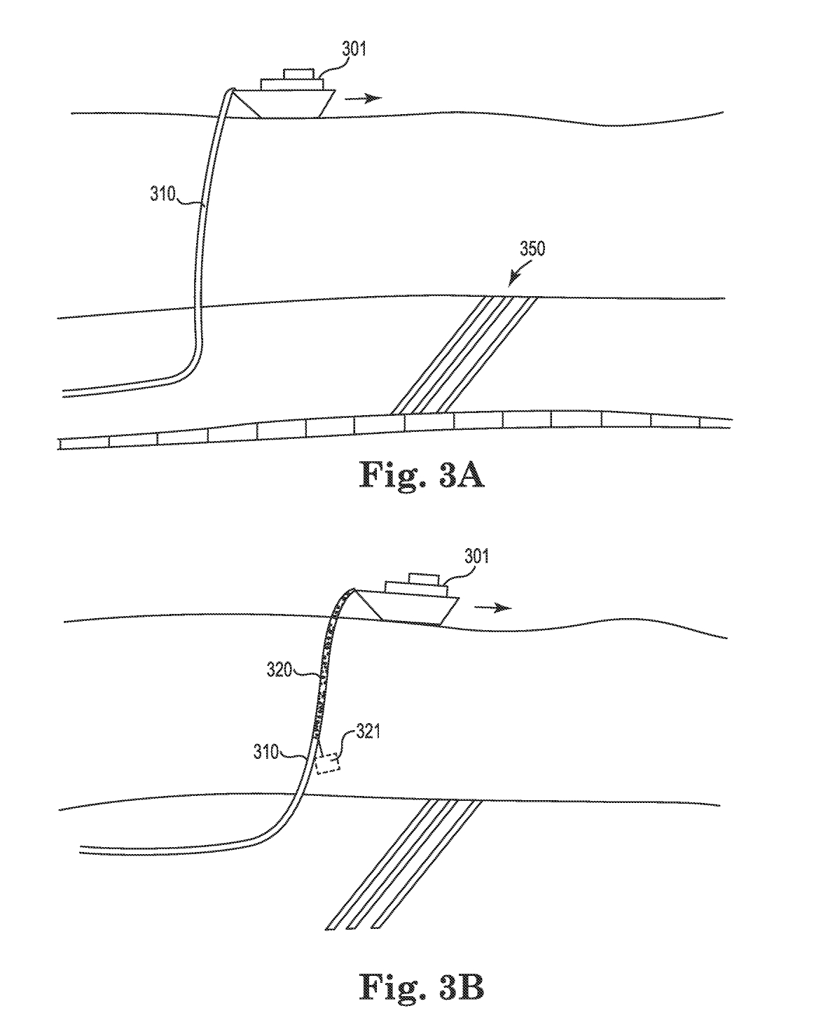

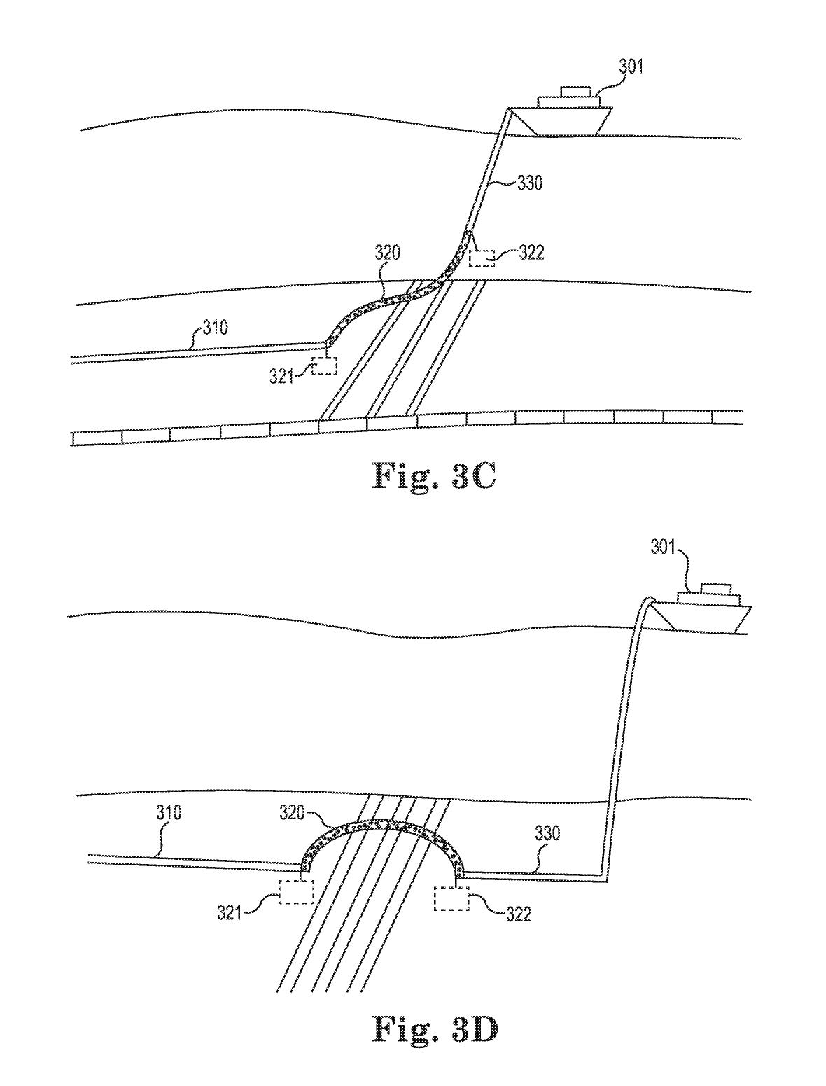

FIGS. 3A-3D illustrate an exemplary method for deploying an ocean bottom cable according to an embodiment of the invention. As illustrated in FIG. 3A, the operations may begin by deploying a first section 310 of an ocean bottom seismic sensor cable to the seabed. As illustrated in FIG. 3A, the deploying vessel 301 may approach an obstruction 350 while deploying the first section 310. In one embodiment, the vessel 301 may include a global positioning satellite (GPS) device and an on board computer comprising one or more maps with information about the location of obstructions on the sea floor. Accordingly, upon approaching the obstruction 350, a second section 320 may be coupled to an end of the first section 310, as illustrated in FIG. 3B. The second section 320 may be a buoyant section configured to float over the obstruction 350, or alternatively, may be a non-buoyant section configured to overlay the obstruction 350, as has been described hereinabove. In one embodiment, an anchor 321 may optionally be coupled to the interface between the first section 310 and second section 320, anchoring the interface to the sea floor.

As the deployment vessel 301 continues to move along and pass over the obstruction 350, a third section 330 may be coupled to an end of the second section 320, as illustrated in FIG. 3C. Again, an anchor 322 may optionally be coupled to an interface between the second section 320 and third section 330, anchoring the interface to the sea floor. The first section 310 and/or the third section 330 may also include one or more seismic sensors or seismic sensor nodes associated therewith, and may be positioned on the seabed where there may be no obstructions, or no substantial obstructions, as illustrated in FIG. 3D. As further illustrated in FIG. 3D, the deployment operations of FIGS. 3A-D may result in the section 320 being positioned above the obstruction. For example, a buoyant and/or passive section 320 may be deployed floating above the obstruction, or a non-buoyant and/or active section 320 may be deployed overlaying the obstruction.

While the foregoing is directed to embodiments of the present invention, other and further embodiments of the invention may be devised without departing from the basic scope thereof, and the scope thereof is determined by the claims that follow.

What is claimed is:

1. An ocean bottom seismic cable, comprising:
a first section comprising a plurality seismic sensors, wherein the first section is positioned on a floor of a body of water in an area where there are no obstructions; and
a second section coupled to the first section, wherein the second section is positioned above an obstruction, and wherein the second section does not include seismic sensors.

2. The ocean bottom seismic cable of claim 1, wherein the first section is configured to transfer at least one of power and communications between two or more of the plurality of seismic sensors.

3. The ocean bottom seismic cable of claim 1, wherein the second section is configured to transfer at least one of power and communications between two or more of the plurality of seismic sensors.

4. The ocean bottom seismic cable of claim 1, wherein the second section is configured to float above the obstruction.

5. The ocean bottom seismic cable of claim 1, wherein the second section is configured to overlay the obstruction.

6. The ocean bottom seismic cable of claim 1, wherein the obstruction comprises one or more of:
a telecommunications line; and
an oil and gas pipeline.

7. The ocean bottom seismic cable of claim 1, wherein the second section comprises a synthetic rope material.

8. The ocean bottom seismic cable of claim 1, wherein the ocean bottom seismic cable further comprises a third section coupled to the second section, wherein the third section comprises one or seismic sensors.

9. The ocean bottom seismic cable of claim 8, further comprising:
a first anchor anchoring the cable to the floor of the body of water at an interface between the first section and the second section; and
a second anchor anchoring the cable to the floor of the body of water at an interface between the second section and the third section;
wherein the second section is configured to be buoyant.

10. The ocean bottom seismic cable of claim 1, wherein first section comprises a plurality of autonomous ocean bottom sensor nodes, wherein each of the autonomous ocean bottom sensor nodes comprises at least one of the plurality of seismic sensors.

11. A method for deploying an ocean bottom seismic cable, comprising:
deploying a first section of the ocean bottom seismic cable on a floor of a body of water, wherein the first section comprises a plurality of seismic sensors;
determining that an obstruction is along a path of deployment of the ocean bottom seismic cable;
in response to determining that an obstruction is along a path of deployment of the ocean bottom seismic cable, coupling a second section of the ocean bottom seismic cable to the first section, wherein the second section is configured to be positioned above the obstruction, and wherein the second section does not include seismic sensors.

12. The method of claim 11, wherein the first section is configured to transfer at least one of power and communications between two or more of the plurality of seismic sensors.

13. The method of claim 11, wherein the second section is configured to transfer at least one of power and communications between two or more of the plurality of seismic sensors.

14. The method of claim 11, wherein the second section is configured to float above the obstruction.

15. The method of claim 11, wherein the second section is configured to overlay the obstruction.

16. The method of claim 11, wherein the obstruction comprises one or more of:
a telecommunications line; and
an oil and gas pipeline.

17. The method of claim 11, wherein the ocean bottom seismic cable further comprises a third section coupled to the second section, wherein the third section comprises one or more seismic sensors.

18. The method of claim 17, further comprising:
anchoring the ocean bottom seismic cable to the floor of the body of water at an interface between the first section and the second section; and
anchoring the ocean bottom seismic cable to the floor of the body of water at an interface between the second section and the third section;
wherein the second section floats above the obstruction between the first anchor and the second anchor.

19. The method of claim 11, wherein the second section comprises a synthetic rope material.

20. The method of claim 11, wherein first section comprises a plurality of autonomous ocean bottom sensor nodes, wherein each of the autonomous ocean bottom sensor nodes comprises at least one of the plurality seismic sensors.
